(19) United States
(12) Patent Application Publication
(10) Pub. No.: US 2006/0290107 A1
(43) Pub. Date: Dec. 28, 2006

(54) Child-scalable stroller

(76) Inventor: Rebecca L. Powers, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/192,160

(22) Filed: Jul. 28, 2005

Related U.S. Application Data
(60) Provisional application No. 60/592,756, filed on Jul. 30, 2004.

(51) Int. Cl. B62B 7/06

(52) U.S. Cl. 280/658

(57) ABSTRACT

A scalable, adjustable stroller/jogger is disclosed that may accommodate one or more than one, child and may be adjusted from stroller to jogger configuration, comprising, in one embodiment, a first seat, a second seat, and a chassis configured to permit the second seat to have at least two distinct positions longitudinally relative to the first seat and, in a preferred embodiment, wherein in at least a first position the second seat is configured to secure a child, and wherein in at least a second position the first seat is not configured to secure a child and is collapsed.

### CROSS-REFERENCE TO RELATED APPLICATIONS

This application claims priority under 35 U.S.C. § 119(e) to U.S. Provisional Application No. 60/592,756, filed on Jul. 30, 2004; which is entitled SCALABLE BABY STROLLER; and which is incorporated herein by reference in its entirety.

### BACKGROUND OF THE INVENTION

1. Field of the Invention

The invention relates to child strollers and joggers and, in addition, to child strollers and joggers adaptable to seat one or more than one children.

2. Description of the Related Art

Child strollers (also known as “carriages”) useful for a variety of situations are well known in the art. Such strollers generally comprise a chassis, wheels, a handle or handles, and seating for at least one child. For example, standard four wheel strollers are useful to transport a single child at a walking pace, on a generally smooth terrain, and may be designed to accommodate either an infant or a larger child. Other strollers, specifically three-wheeled child strollers with three fixed-direction wheels or wheel pairs, also known as child “joggers” or “jogging strollers,” are often specifically designed and constructed to permit transporting a child at a faster pace, for example, at a jogging pace or, for example on relatively uneven or rough terrain. The design and construction of such jogging strollers often sacrifices maneuverability to improve stability and durability.

Further, double strollers (or other multiple-child strollers) permit the user to transport two (or more) children in a single stroller. Likewise, double stroller variants of jogging strollers are known. Purchasing, storing, and otherwise maintaining different strollers, each useful for a different situation or desired pace (for example, to transport a given number of children or to accommodate transport at a faster pace) present numerous problems. For example, each stroller may be relatively expensive. Moreover, even if a user owns multiple types of strollers, use and/or travel with multiple suitable strollers is often impractical.

Thus, a need exists for a single stroller having improved adaptability. For example, a need exists for a stroller capable of accommodating either one or more than one child by, for example, readily converting from a single-child stroller to a multiple-child stroller. Also for example, a need exists for a stroller capable of readily converting from stroller suitable for a walking pace or use on a relatively smooth terrain to a stroller suitable to a faster pace or use on a relatively rough terrain.

### SUMMARY OF CERTAIN ASPECTS

The system, method, and devices disclosed each have several aspects, no single one of which is solely responsible for its desirable attributes. Without limiting the scope of this invention as variously expressed by the claims which follow, certain of the more prominent features will now be discussed briefly. After considering this discussion, and particularly after reading the section entitled “Detailed Description of the Embodiments” persons of skill in the art will understand how the features provide an adaptable child mobility solution that reduces the need for a user to have a multiplicity of different strollers for different situations.

A scalable stroller (or jogger) is disclosed comprising in one embodiment a first seat, a second seat, and a chassis configured to permit the second seat to have at least two distinct positions longitudinally relative to the first seat and, in a preferred embodiment, wherein in at least a first position the second seat is configured to secure a child, and wherein in at least a second position the first seat is not configured to secure a child and is collapsed. In other preferred embodiments, the first seat, when in the second position, is more proximal to the second seat than in a first position. The disclosed stroller or jogger may preferably further comprise a wheel assembly, wherein the wheel assembly is removably attached to the chassis or the wheel assembly may comprise a strut coupled to at least one wheel. The wheel may comprise a fixed orientation or variable wheel or wheel pair or other means or transit and support. The wheel assembly may comprise at least two struts, each of the two struts coupled to at least two wheels. Alternatively, the scalable stroller comprises a first seat; a chassis configured to position the first seat in at least two locations with respect to at least one fastener; and the at least one fastener configured to affix a second seat in front of the first seat. Alternatively, the stroller for transporting children comprises a central longitudinal strut, at least two outer longitudinal struts wherein each of the longitudinal struts is configured to pivot with respect to the central longitudinal strut, a lower lateral strut comprising center member and at least two telescoping members wherein the central longitudinal strut is centrally coupled to the lower lateral strut and wherein each of the outer longitudinal struts is coupled to a respective one of the telescoping members of the lateral strut, an upper lateral strut comprising center member and at least two telescoping members wherein the central longitudinal strut is centrally coupled to the lateral strut; at least one vertical strut coupled to the lateral strut; and handlebar coupled to the at least one vertical strut. This stroller may further comprise a least one seat configured to be affixed to at least one of the lower and the upper lateral strut, or may further comprise: a first seat configured to be affixed to the at least one vertical strut at a first position relative to the lower lateral strut; and at least a second seat configured to be affixed to the at least one vertical strut at a second position relative to the lower lateral strut. Alternatively, a scalable stroller comprising a first longitudinal strut comprising at least three telescoping members; a first strut coupled to a first of the telescoping members and configured to secure a first seat; a second strut coupled to a second of the telescoping members and configured to secure a second seat; and a second longitudinal strut comprising a first and second member wherein the first member has a first end rotatably coupled to the first vertical strut and a second end rotatably coupled to a first end of the second member and wherein the second member has a second end rotatably coupled to the second vertical strut. Preferably, this stroller comprises at least three telescoping members are configured to position the second seat to at least two locations relative to the first seat.

Also disclosed is a method of using a stroller having first and second seats, the method comprising: adjusting the length of at least one chassis member to position the first seat at a first position relative to the second seat wherein in the first position, the first seat is configured to secure a child; and adjusting the length of the least one chassis member to position the first seat at a second position relative to the second seat wherein in the second position, the first seat is not configured to secure a child. Preferably, the adjusting step involves adjusting the length of the least one chassis member to position the first seat at a second position comprises collapsing the first seat, or this step involves adjusting the length of the least one chassis member comprises extending a telescoping portion of the chassis member. This method may further comprise removing a first removably detached wheel assembly; and attaching a second removably detached wheel assembly, wherein the one of the first or second removably detached wheel assemblies comprises at least one fixed orientation wheel and wherein the other of the one of the first or second removably detached wheel assemblies comprises at least one fixed orientation wheel.

Also disclosed is a method of making a stroller, the method comprising affixing a first seat to at least one chassis member; affixing a second seat to the least one chassis member, wherein the at least one chassis member is configured to be adjustable in length and wherein the at least one chassis member is configured to position the first seat at a first position relative to the second seat wherein in the first position, the first seat is configured to secure a child; and wherein the at least one chassis member is configured to position the first seat at a second position relative to the second seat wherein in the second position, the first seat is not configured to secure a child. This method may include affixing a first seat comprises affixing the first seat wherein the first seat is collapsed at least in the second position, or may further comprise the steps of selecting a removably detached wheel assembly from a plurality of removably detached wheel assemblies, and optionally attaching the selected removably detached wheel assembly, wherein at least one of the detached wheel assemblies comprises at least one fixed orientation wheel.

Also disclosed is a scalable stroller comprising a first seat, a second seat; and a chassis configured to permit the second seat to have at least two distinct positions latitudinal relative to the first seat, wherein in at least a first position the second seat is configured to secure a child, and wherein in at least a second position the first seat is not configured to secure a child and is collapsed. Also disclosed is a scalable stroller comprising a first seat; a second seat; a third seat; a fourth seat; and a chassis configured to permit the second seat to have at least two distinct positions latitudinal relative to the first seat, a chassis configured to permit the third seat to have at least two distinct positions longitudinal relative to the first seat, a chassis configured to permit the fourth seat to have at least two distinct positions relative to the first seat, wherein in at least a first position the second seat is configured to secure a child, and wherein in at least a second position the first seat is not configured to secure a child and is collapsed.

### BRIEF DESCRIPTION OF THE DRAWINGS

FIG. 1 is a side view of an embodiment of a scalable stroller adapted for a single child with bonnet depicted.

FIG. 2 is a cut-away side schematic view illustrating certain components of the embodiment of the stroller depicted in FIG. 1, without bonnet depicted.

FIG. 3 is a side view of an embodiment of the stroller of FIG. 1 adapted for two children.

FIG. 4 is a side schematic view illustrating certain components of the embodiment of the stroller depicted in FIG. 4.

FIG. 5 illustrates a front perspective view of the embodiment of the stroller depicted in FIG. 3.

FIG. 6 is a view of an embodiment of the stroller of FIG. 5 in a jogger configuration, where a two wheel pair front wheel member is replaced with a single wheel pair member and the single wheel pair member has been affixed to the stroller.

FIG. 7 is a view of a schematic of an alternative embodiment of the stroller in an alternative jogger configuration.

### DETAILED DESCRIPTION OF EMBODIMENTS OF THE INVENTION

The following detailed description is directed to certain specific embodiments of the invention. The invention can, however, be embodied in any of a multitude of different manners or ways using differing devices or methods as defined and covered by the claims. In this detailed description, references are made to the drawings wherein like parts are designated with like numerals throughout.

Even when multiple strollers suitable for different situations are available, each individual stroller is often of limited Value or use because it is unlikely that a particular stroller well suited to a particular situation is not adaptable to other situations. Thus, it has been found that it is desirable for a stroller to be adaptable to hold one or more than one child while also being adaptable for both various paces or terrains, for example walking and jogging situations or both smooth and rough terrains. Such a stroller reduces the need for multiple strollers and reduces the inconvenience of not having a single stroller that is adapted to more than one specific situation.

A stroller typically includes four wheels, or four pairs of wheels (“wheel pairs”) mounted via struts or other suitable mounting means to a chassis. The rear wheels may be mounted to the struts so as to have a fixed orientation (“fixed direction wheels”) or may have rotatable wheels or wheel pairs. The front wheels or wheel pairs are typically rotatably mounted on their struts. The front wheels thus may swivel to allow the stroller to turn more sharply permitting greater maneuverability than having four fixed wheels, for example, to allow easier maneuvering through the aisles of a store. When such a stroller is moved at a faster rate, for example, when the stroller is pushed by a person while jogging, having rotatably mounted front wheels may tend to cause the stroller to be unstable and to be relatively difficult to steer.

The wheels, either individually or as wheel pairs, are designed to convey the stroller or jogger when force is applied, and may be configured to accommodate one or more suitable braking mechanisms such as, for example, a physical stop that may be interposed within in a series of radial spokes on at least one side of the wheel or a mechanical, electric or electromechanical stop mechanism. The wheels or wheel pairs are meant to encompass, and thus may be replaced by, any suitable means of conveyance such as, for example, casters or treads.

The wheels, either individually or as wheel pairs, may be constructed of any suitable material include, for example, suitable high impact plastics, rubber or reinforced rubber, or resins. The wheels, either individually or as wheel pairs, may have any suitable width and any suitable radius. Suitable widths will typically be in the range of from less than one inch to two, three, four, five or six inches; suitable radii will typically be in the range from several inches to a foot, to two or three feet or greater. Although all wheel widths and radii are contemplated, relatively greater widths and relatively larger radii are generally preferred to impart stability, especially when wheels pairs are employed and especially with respect to the fixed direction wheels of the jogger configuration, in relatively more rapid transit or for transit over relatively rough or uneven terrain; relatively lesser widths and relatively lesser radii are generally preferred for ease of handling and maneuverability, especially with respect to the four wheel or four wheel pair configuration, in relatively slower transit or for transit over relatively even terrain.

The terms “jogger” and “jogging stroller,” as used herein, refer to a type of stroller that typically includes three, or three pair, of fixed orientation wheels arranged with two nearer the back and one nearer the front of the stroller. “Fixed orientation” wheels refer to wheels or wheel pairs that are mounted on the strut or other mounting means so as to have fixed orientation with respect to the chassis. “Rotatably mounted” wheels are mounted such that the wheels are free to rotate through some range, and are attached to the chassis, or the wheels are fixed to the strut and the strut rotatably attached to the chassis. A single stroller may be configured to be adapted for use in jogging or walking situations.

While certain embodiments may be discussed with respect to certain features, it is to be appreciated that embodiments may include one or more of the particular features of the particular embodiments disclosed herein. For example, embodiments may be configured to be adapted to accommodate either one child or for two, three or four or more children. Embodiments may also be configured to be adapted between a typical stroller configuration and a jogger configuration. Other embodiments may include more than one of these adaptability features.

As used herein, the term “chassis” generally refers to a frame to which wheels, wheel pairs, wheel struts or wheel pair struts and other components of a stroller may be substantially permanently or detachably affixed. The chassis, or other components, of a stroller may include telescoping structural members and struts.

As used herein, the term “telescoping” generally means that the described element may be adjustable in length. For example, a telescoping structural member may include an outer piece that is at least partially hollow and an inner piece that is slidingly engaged lengthwise within the hollow to enable the two pieces together to form a structural member with a variable length. Telescoping members may optionally be configured to prefer a longer size, for example, by including a spring within the hollow portion that tends to push the two pieces apart. Such telescoping members may include other mechanisms, for example, detents or catches for maintaining the components at any number of lengths. Telescoping elements are preferable comprised of light weight, substantially rigid materials. Such materials include, but are not limited to, metals such as aluminum alloys, plastics such as polyvinylpyrolidone or polyethylene or other relatively rigid materials.

Other stroller components may be configured so that they are detachable from the stroller or from the other stroller components. The term “detachable” component generally refers to a component that is removably attached to one or more other components. The component may be configured to be attached such that it may also be removed. Preferably, detachable components are not glued or soldered, but are rather slidingly engaged within, for example, are configured with, a fitted hollow, are coupled via hook and loop materials, are coupled via fasteners such as screws, bolts or otherwise removably attached by any means known to those of skill in the art.

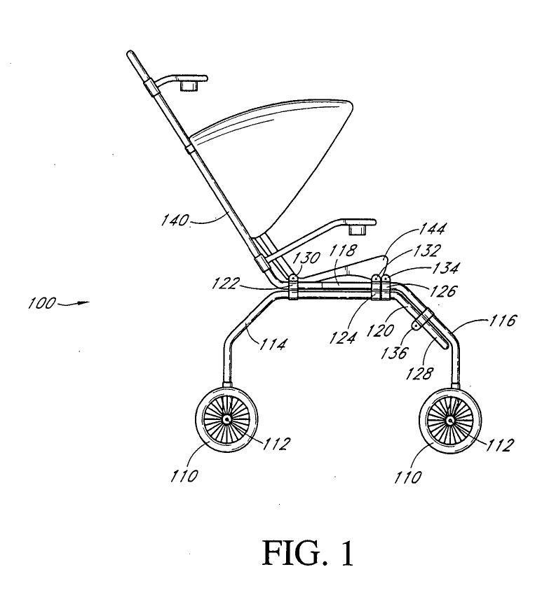

FIG. 1 is a side view of embodiment of a scalable stroller 100 in a configuration adapted for seating a single child. The stroller 100 includes one or more seats 102. One or more of the seats 102 may include a bonnet 104 configured to shield the occupant of the seat from, for example, sunlight or rain or wind.

The stroller 100 may include a pair of rear wheels or wheel pairs 110. An axle 112 couples each rear wheel 110 to a rear strut 114. In a four wheel configuration, the stroller 100 also includes a pair of front wheels 110. Another axle 112 couples each front wheel 110 to a front strut 116.

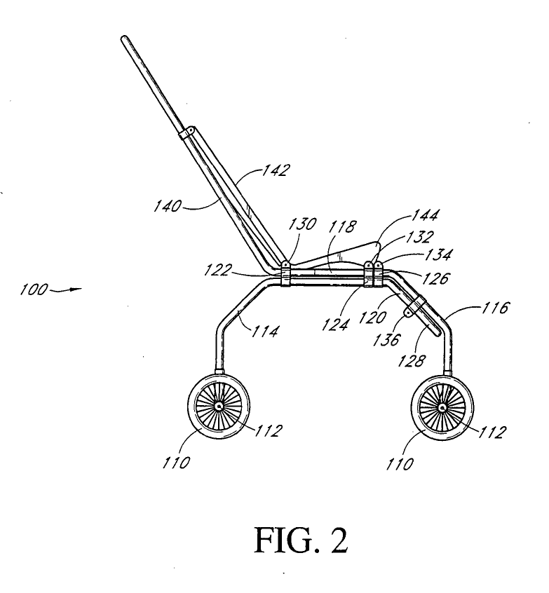

FIG. 2 is a side schematic view illustrating certain components of the embodiment of the stroller depicted in FIG. 1. Each front strut 116 is coupled to an upper chassis member 118. In one embodiment, each upper chassis member 118 and the corresponding front strut 116 is integrally formed as a single member. In another embodiment, the front strut is coupled to a front transverse strut (not shown). Each rear strut 114 is coupled to a lower chassis member 120. In one embodiment, the rear strut 114 and each lower chassis member 120 is integrally formed as a single member. Preferably, the upper chassis member 118 and the lower chassis member 120 are substantially parallel to each other. One or more transverse struts (not shown) connect the upper and lower chassis members 118 and 120 on each side of the stroller 100.

The upper and lower chassis members 118 and 120 are coupled at one or more locations along each member. In one embodiment, structural clips 122, 124, 126, and 128 affix the chassis members 118 and 120 to one another. In addition to securing the chassis members together, the clips 122, 124, 126, and 128 may provide attachment mechanisms for one or more of the seats 102. In a two seat embodiment, attachment members 130 and 132 may be configured to affix the rear seat 102 and attachment members 134 and 136 configured to affix the front seat 102. In one embodiment, the attachment members 130, 132, 134, and 136 may include an orifice configured to receive a spring loaded detent (not shown). In other embodiments, the attachment members 130, 132, 134, and 136 may include other mechanisms of permanent or temporary attachment such as are well known in the art.

The stroller 100 may also include a handle (not shown) connected to the chassis members 118 via a handle strut 140. The rear seat 102 may include an upright chassis 142 and a bottom chassis 144. The seat body (not shown) may include a flexible, e.g., fabric, material.

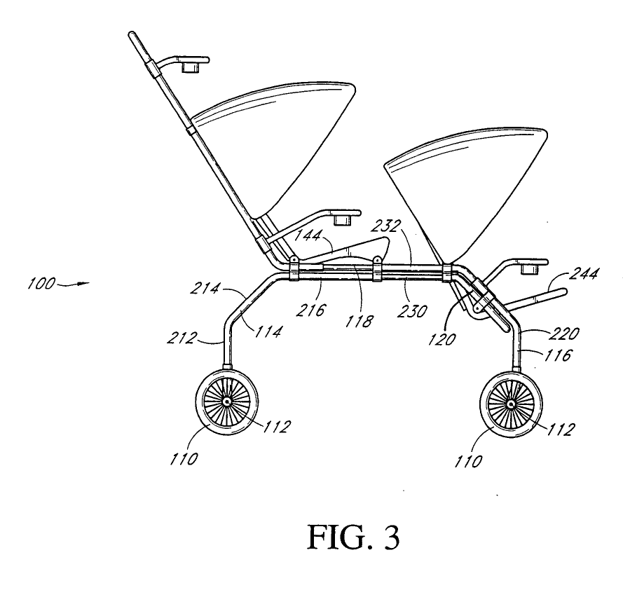

FIG. 3 is a side view of an embodiment of the stroller of FIG. 1 adapted for two children. A second seat 204 may be attached to attachment members 134 and 136. The upper and lower chassis members 118 and 120 are configured to be lengthened to provide enough space for the occupant of the second seat 204. In one embodiment, the second seat 204 may be detached when the chassis members 118 and 120 are retracted into the single seat 104 configuration. In another embodiment, when the chassis members 118 and 120 are shortened, hinges (not shown) may rotate the seat 204 under the seat 104.

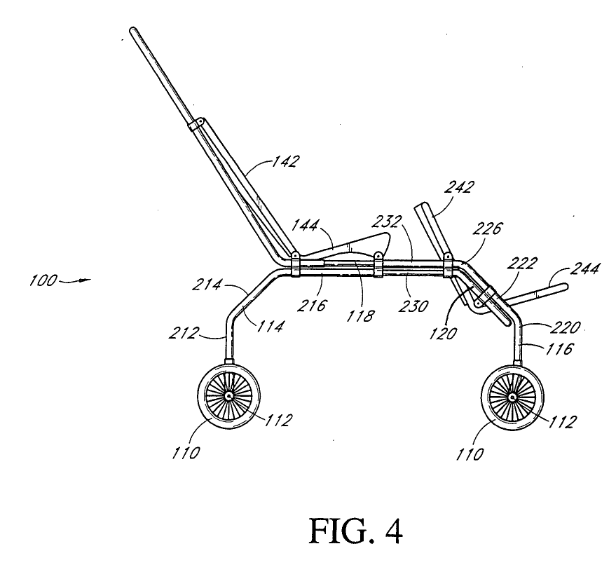

FIG. 4 is a side schematic view illustrating certain components of the embodiment of the stroller depicted in FIG. 4. To enable lengthening and shortening of the upper chassis member 118, and the lower chassis member, each may include rear chassis members 214 and 216 from which extendible lower and upper chassis members 230 and 232 telescope. In another embodiment, the lower and upper chassis members 118 and 120 further include a duel telescoping chassis that includes upper and lower front members 220 and 222 which can be extended from the extendible upper and lower chassis members 232 and 230. In one embodiment, the rear members 214 and 216 are at least partially hollow and configured to receive the extendible members 230 and 232. In one embodiment, a spring (not shown) is disposed within the rear members 214 and 216 so as to provide resistance to insertion of the extendible members 230 and 232. The extendible members 230 and 232 may include spring loaded detents (not shown) which project through orifices (not shown) in the rear members 214 and 216 to lock the extendible members 230 and 232 in place so that the members 118 and 120 have a selected length. In embodiments, including front members 220 and 222, similar spring based mechanisms may be used to allow convenient extension of the front members 220 and 222 with respect to the extendible members 230 and 232.

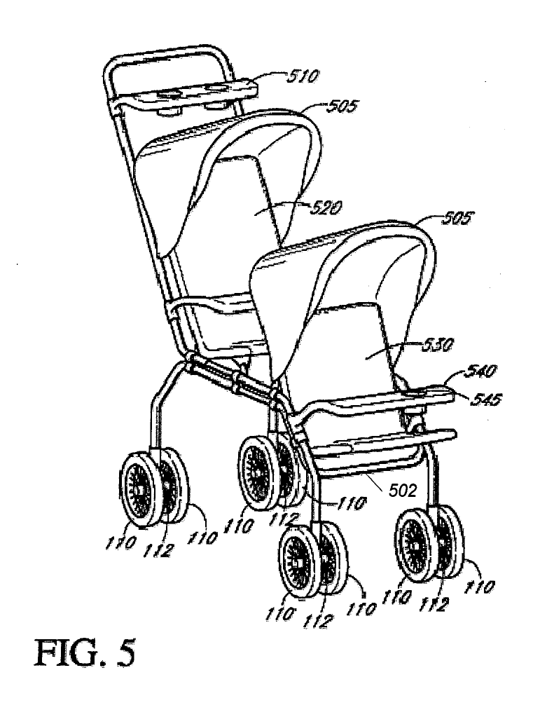

FIG. 5 illustrates a front perspective view of the embodiment of the stroller 100 depicted in FIG. 3. In this embodiment, each wheel strut 114 and 116 is coupled to two wheels 110 via the axle 112. The front transverse strut 502 is also depicted. This desirably increases the stability of the stroller 100. Each seat 104 and 204 may include a fabric or mesh seat back 520 a tray modified to include and 530. The stroller 100 may be conveniently equipped with other accessories such as drink holders 510 or an unmodified tray (not shown). In addition, the seat backs 520 and 530 may include a second sheet of material so as to form a storage pocket (not shown) on the back face of each seat. In one embodiment, the seat back 520 may be configured to include a pocket or other mechanism, such as a clip, hook and loop fasteners to affix the second seat 204 when not in use.

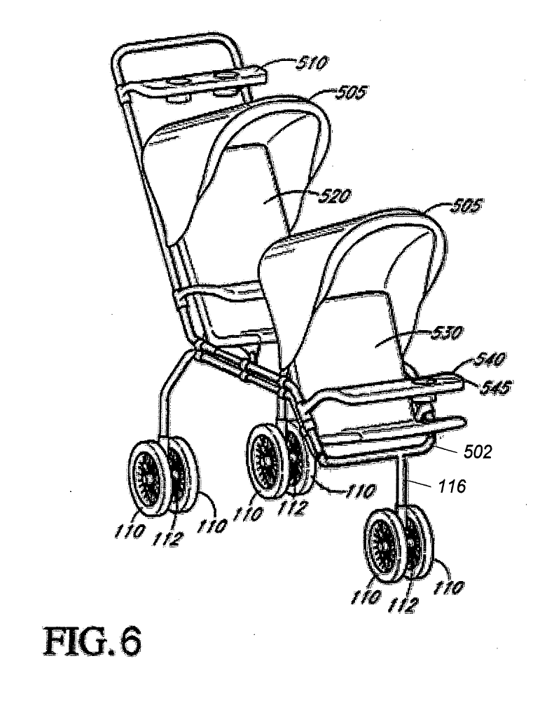

FIG. 6 is a view of an embodiment of the stroller of FIG. 5 in which a two wheeled front wheel member is replaced with a single wheeled member has been affixed to the stroller. In one embodiment, the entire transverse strut 502 and front struts 116 may be removed and replaced by the single wheel 110 projecting from the front strut 116, which in turn projects from transverse strut 502. In one embodiment, the chassis members 118 and 120 are at least partially hollow, such that they include a recess that is configured to receive the ends of the front lateral member 502.

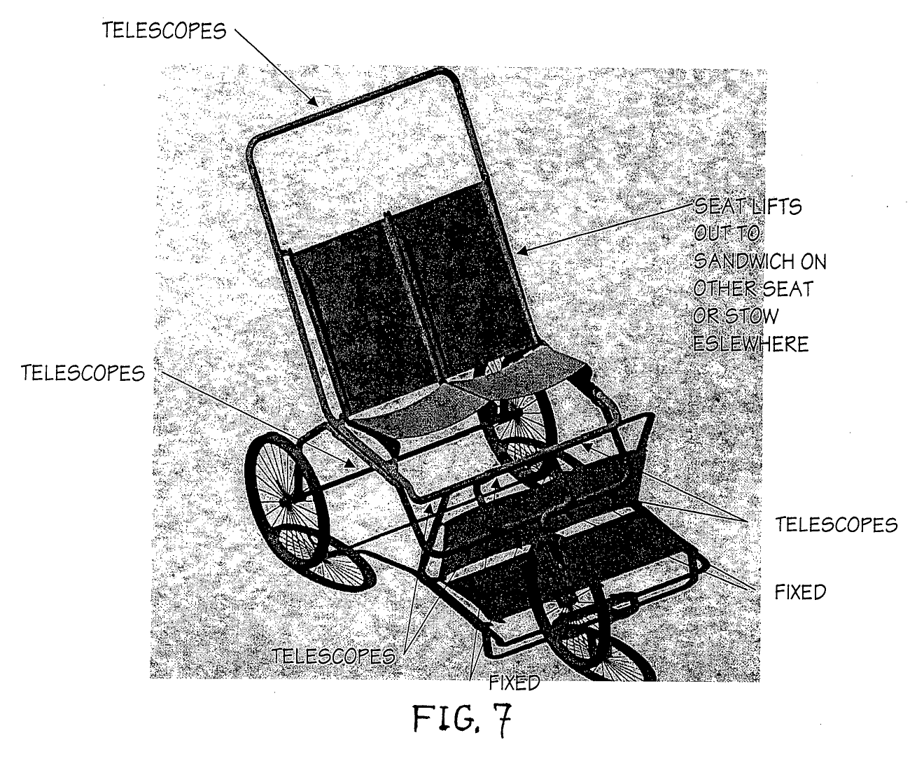

FIG. 7 is a view of a schematic of an alternative embodiment of the stroller in an alternative jogger configuration. In this schematic, telescoping members are provided along both axes of the stoller/jogger, along the axis substantially perpendicular to the transport axis of the stroller and along the axis substantially along the transport axis of the stroller or jogger.

As exemplified in FIG. 7, and in various other configurations as will be appreciated by those skilled in the art, a telescoping chassis members may be employed in individual pairs, along a single axis, or in more than one pair, along two or more or multiple axes. The telescoping chassis members may permit lengthening or shortening of the chassis, permitting the use of one or more additional seats substantially along the transport axis of the stroller or jogger. Such telescoping chassis members are depicted, for example, in an extended configuration in FIGS. 3, 4 and 5, accommodating two seats front to back. Also disclosed as alternative embodiments are stroller and joggers in which the telescoping chassis members accommodate up to three seats front to back, through two distinct steps of expansion. Suitable means, including reinforcements or couples may be used to stabilize the extended chassis member in the two seat or three seat extended configuration. Suitable additional support mechanism, including additional retractable wheels or other horizontal support members may be employed to support the extended chassis member at positions remote from the extant struts and wheels in the two seat or three seat extended configuration.

The telescoping chassis members may be employed along more than one axis. For example, one set of telescoping chassis members may permit lengthening or shortening of the chassis, and another distinct set of telescoping chassis members may permit widening or narrowing of the chassis. For example, one set of telescoping chassis members may permit the use of one or more additional seats substantially along the transport axis of the stroller or jogger, while another set of telescoping chassis members permits the use of one or more additional seats substantially perpendicular to the transport axis of the stroller or jogger.

Telescoping chassis members that are expandable along an axis substantially perpendicular to the transport axis of the stroller or jogger, while not specifically depicted in any figure, are contemplated and encompassed by this disclosure. Also disclosed as alternative embodiments are stroller and joggers in which such telescoping chassis members are expandable to accommodate up to three seats side-to-side, through two distinct steps of expansion. Suitable means, including reinforcements or couples may be used to stabilize such extended chassis member in the two seat or three seat extended configuration. Suitable additional support mechanism, including additional retractable wheels or other horizontal support members may be employed to support the extended chassis member at positions remote from the extant struts and wheels in the two seat or three seat extended configuration.

Telescoping chassis members that are expandable along an axis substantially perpendicular to the transport axis of the stroller or jogger may be combined with telescoping chassis members that are expandable along an axis substantially along the transport axis of the stroller or jogger. Strollers or joggers having such combination of expandable chassis members are expandable to accommodate up to four seats, two side-to-side in front and two, side-to-side, in back, and may be expanded first to accommodate two children in a distinct step of expansion and two more children through another distinct step of expansion. Suitable means, including reinforcements or couples may be used to stabilize such extended chassis member in the two seat or four seat extended configuration. Suitable additional support mechanism, including additional retractable wheels or other horizontal support members may be employed to support the extended chassis member at positions remote from the extant struts and wheels in the two seat or four seat extended configuration.

Embodiments of the stroller 100 may desirably include a variety of materials. For example, the structural elements, e.g., chassis members and struts, may desirably be constructed of a light weight, substantially rigid, and durable material. These materials may include metals such as aluminum, titanium or steel. The materials may also include any suitable plastic, polymer, resin or fiber, such as carbon fiber or fiberglass. In addition, in some embodiments, these materials may include a combination of such materials, for example, a plastic member having metal cores for additional rigidity.

The bonnet 104 is preferably constructed of a material that reduces the amount of sunlight incident on the stroller passengers. Desirably, the bonnet material is also lightweight. For example, the bonnet 104 may include a mesh composed of a polyester or cotton material, or other at least partially opaque material. In other embodiments, a translucent or transparent material may be used. Such materials are preferably configured to block ultraviolet radiation. The bonnet material 104 may also be water resistant or water repellant to better protect the seat area from rain. In one embodiment, the bonnet 104 may be configured to pull forward and down so as to completely cover at least one of the seats. The bonnet 104 may be of any color. In one embodiment, the bonnet may include combinations of colors, or images, selected to be visually appealing. The colors inside the bonnet 104, visible to the occupants of the stroller 100 may include entertaining patterns, images, or montages. In one embodiment, the bonnet 104 may include colors or other visual features, such as reflective devices or materials, so as to improve the visibility of the stroller.

The seat backs 520 and 530 may be constructed of a material that is preferably lightweight and substantially flexible. For example, the seat backs 520 and 530 may include a breathable material, i.e., a material that does not trap moisture next to an occupant's body. Such breathable materials may includes a mesh or other material, e.g., cotton, that tends to transport moisture away from the occupant. The seats material may include colors that are decorative or entertaining. In addition, the seat material may be brightly colored, or otherwise include visual features, such as reflective devices or materials, so as to increase the visibility of the stroller.

In addition to the drink holder 510, which is preferably configured to be reachable by a user while pushing the stroller, the stroller may also include a drink holder for the occupant of the seats. In one embodiment, the tray is modified to may include a drink holder. Embodiments of the stroller 100 may also include any number of other accessories. These accessories may include entertainment devices, such as mobiles with toys or other visually stimulating items. The accessories may also include electronic devices such as music or video players, DVD players and a video display screen. Such embodiments may also include audio loudspeakers, which may be affixed to, or concealed within, the bonnet 510.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A scalable stroller comprising:
a first seat;
a second seat; and
a chassis configured to permit the second seat to have at least two distinct positions longitudinally relative to the first seat,
wherein in at least a first position the second seat is configured to secure a child, and
wherein in at least a second position the first seat is not configured to secure a child and is collapsed.

2. The scalable stroller of claim 1, wherein in the second position, the first seat is more proximal to the second seat than in a first position.

3. The scalable stroller of claim 1, further comprising a wheel assembly, wherein the wheel assembly is removably attached to the chassis.

4. The scalable stroller of claim 3, wherein the wheel assembly comprises a strut coupled to at least one wheel.

5. The scalable stroller of claim 4 wherein the at least one wheel comprises a fixed orientation wheel.

6. The scalable stroller of claim 3, wherein the wheel assembly comprises at least two struts, each of the two struts coupled to at least two wheels.

7. The scalable stroller of claim 4, wherein the wheel assembly comprises at least two struts, each of the two struts coupled to at least two wheels.

8. A stroller for transporting children comprising:
a central longitudinal strut;
at least two outer longitudinal struts wherein each of the longitudinal struts is configured to pivot with respect to the central longitudinal strut;
a lower lateral strut comprising center member and at least two telescoping members wherein the central longitudinal strut is centrally coupled to the lower lateral strut and wherein each of the outer longitudinal struts is coupled to a respective one of the telescoping members of the lateral strut;
an upper lateral strut comprising center member and at least two telescoping members wherein the central longitudinal strut is centrally coupled to the lateral strut;
at least one vertical strut coupled to the lateral strut; and
a handlebar coupled to the at least one vertical strut.

9. The scalable stroller of claim 8, further comprising:
a least one seat configured to be affixed to at least one of the lower and the upper lateral strut.

10. The scalable stroller of claim 8, further comprising:
a first seat configured to be affixed to the at least one vertical strut at a first position relative to the lower lateral strut; and
at least a second seat configured to be affixed to the at least one vertical strut at a second position relative to the lower lateral strut.

11. A scalable stroller comprising:
a first longitudinal strut comprising at least three telescoping members;
a first strut coupled to a first of the telescoping members and configured to secure a first seat;
a second strut coupled to a second of the telescoping members and configured to secure a second seat; and
a second longitudinal strut comprising a first and second member wherein the first member has a first end rotatably coupled to the first vertical strut and a second end rotatably coupled to a first end of the second member and wherein the second member has a second end rotatably coupled to the second vertical strut.

12. The scalable stroller of claim 11, wherein the at least three telescoping members are configured to position the second seat to at least two locations relative to the first seat.

13. A method of using a stroller having first and second seats, the method comprising:
adjusting the length of at least one chassis member to position the first seat at a first position relative to the second seat wherein in the first position, the first seat is configured to secure a child; and
adjusting the length of the least one chassis member to position the first seat at a second position relative to the second seat wherein in the second position, the first seat is not configured to secure a child.

14. The method of claim 13, wherein adjusting the length of the least one chassis member to position the first seat at a second position comprises collapsing the first seat.

15. The method of claim 13, wherein adjusting the length of the least one chassis member comprises extending a telescoping portion of the chassis member.

16. The method of claim 13, further comprising:
removing a first removably detached wheel assembly; and
attaching a second removably detached wheel assembly,
wherein the one of the first or second removably detached wheel assemblies comprises at least one fixed orientation wheel and
wherein the other of the one of the first or second removably detached wheel assemblies comprises at least one fixed orientation wheel.

17. A method of making a stroller, the method comprising:
affixing a first seat to at least one chassis member;
affixing a second seat to the least one chassis member, wherein the at least one chassis member is configured to be adjustable in length and
wherein the at least one chassis member is configured to position the first seat at a first position relative to the second seat wherein in the first position, the first seat is configured to secure a child; and
wherein the at least one chassis member is configured to position the first seat at a second position relative to the second seat wherein in the second position, the first seat is not configured to secure a child.

18. The method of claim 17, wherein affixing a first seat comprises affixing the first seat wherein the first seat is collapsed at least in the second position.

19. The method of claim 17, further comprising:
selecting a removably detached wheel assembly from a plurality of removably detached wheel assemblies.
attaching the selected removably detached wheel assembly,
wherein at least one of the detached wheel assemblies comprises at least one fixed orientation wheel.

20. The method of claim 19, wherein one other of the removably detached wheel assemblies comprises at least one fixed orientation wheel.

21. A scalable stroller comprising:
a first seat;
a second seat; and
a chassis configured to permit the second seat to have at least two distinct positions latitudinal relative to the first seat,
wherein in at least a first position the second seat is configured to secure a child, and
wherein in at least a second position the first seat is not configured to secure a child and is collapsed.

22. The scalable stroller of claim 21, further comprising:
a third seat;
a fourth seat;
a chassis configured to permit the third seat to have at least two distinct positions longitudinal relative to the first seat, and
a chassis configured to permit the fourth seat to have at least two distinct positions relative to the first seat,
wherein in at least a first position the second seat is configured to secure a child, and
wherein in at least a second position the first seat is not configured to secure a child and is collapsed.
